(19) United States
(12) Patent Application Publication
(10) Pub. No.: US 2006/0087689 A1
(43) Pub. Date: Apr. 27, 2006

(54) Image processing device, image forming apparatus, image forming system, image forming program, image processing program, and computer readable recording medium

(76) Inventors: Motohiro Hayashi, Nara-shi (JP); Kazunori Miyamoto, Kashihara-shi (JP); Yoshinori Hayashi, Soraku-gun (JP); Naoyuki Kamei, Yamatokoriyama-shi (JP); Kouichi Eto, Nara-shi (JP)

Correspondence Address: NIXON & VANDERHYE, PC, 901 NORTH GLEBE ROAD, 11TH FLOOR, ARLINGTON, VA, 22203, US

(21) Appl. No.: 11/257,126

(22) Filed: Oct. 25, 2005

(30) Foreign Application Priority Data
Oct. 25, 2004 (JP) 2004-310056

(51) Int. Cl. G06F 3/12

(52) U.S. Cl. 358/1.15; 358/521

(57) ABSTRACT

An image processing device includes: (a) an identification ID/gradation correction data storage section for storing the gradation correction data items which are for use in generating, from image data, a plurality of output image data items subjected to gradation correction, respectively; (b) a set preparing section for (i) generating the output image data items by carrying out the gradation correction with respect to the image data in accordance with the gradation correction data items respectively, and (ii) preparing, in accordance with the gradation correction data items stored in the identification ID/gradation correction data storage section, plural sets by rendering, to the output image data items, identification information for identifying the gradation correction data items used for the generation of the output image data items, respectively; and (c) a transmitting/receiving section for transmitting the plural sets to a common transmission destination of the image forming apparatuses, via a host communication section.

This Nonprovisional application claims priority under 35 U.S.C. § 119(a) on Patent Application No. 2004/310056 filed in Japan on Oct. 25, 2004, the entire contents of which are hereby incorporated by reference.

### FIELD OF THE INVENTION

The present invention relates to an image forming system in which information is exchanged between an image forming apparatus and an image processing device for generating an output image.

### BACKGROUND OF THE INVENTION

A copied image and a printed image are different in terms of density reproducibility and gradation reproducibility. Such a difference in the density reproducibility and the gradation reproducibility is caused by (i) a short-term change arisen from an environmental change of an apparatus; (ii) a long-term change arisen from a change (deterioration) in a photoreceptor and a developer with passage of time; and the like. For elimination of the difference between the copied image and the printed image in the density reproducibility and the gradation reproducibility, correction needs to be carried out in accordance with such changes.

In an image forming apparatus, such an image density reproducibility and/or gradation reproducibility cannot be maintained due to the environmental change (temperature, humidity, etc.) or the aging of the apparatus (drum, development layer). Many calibration methods have been proposed to maintain the image density reproducibility and/or gradation reproducibility so that such changes never affect the image density reproducibility and/or the gradation reproducibility. Conventionally, a calibration mechanism has been generally provided in a printer. Specifically, a print controller processing section, provided in the image forming apparatus, carries out (i) the CMM (color management module) processing, (ii) the TRC output γ correction, and (iii) the HT (half tone) processing with respect to image data generated by using an application provided in the image processing device (information processing apparatus). Then, the image data thus processed is supplied to an engine provided in the image forming apparatus.

However, a printer has a very poor information processing performance as compared with that of a computer, and the performance is becoming unable to fully meet a recent demand of high quality image. Further, integrating the calibration functions into the printer possibly makes the printer expensive.

Consequently disclosed is such an arrangement that the functions for correcting image quality of an output image are separately given in the information processing apparatus and the image outputting apparatus. Specifically, the image processing device (information processing apparatus) carries out the (i) the CMM (color management module) processing, (ii) the TRC output γ correction, and (iii) the HT (half tone) processing with respect to image data generated by using an application. Then, the image processing device sends the image data thus gradation-corrected, to the engine of the image forming apparatus.

Specifically, Japanese Unexamined Patent Publication Tokukaihei 10-181102/1998 (published on Jul. 7, 1998) discloses a technique for distributing loads to be imposed on the image forming apparatus, by causing a host computer to handle the calibration mechanism.

As is the case with the arrangement disclosed in the above patent publication, Japanese Unexamined Patent Publication Tokukai 2002-207327/2002 (published on Jul. 26, 2002) discloses such an arrangement that a host computer carries out the calibration. However, the calibration is performed so that the same output density is obtained not only in a specific image forming apparatus connected peer-to-peer with the host computer, but also in several image forming apparatuses connected through a network.

Meanwhile, proposed in, e.g. Japanese Unexamined Patent Publication Tokukai 2003-271348/2003 (published on Sep. 26, 2003), etc., is such an arrangement that: the host transmits a print job to a common virtual address given to a group of printers, and the print job thus transmitted is processed by a suitable printer selected in accordance with each job processing state of the printers.

However, only the following case is taken into consideration in such a technique of generating, in accordance with a calibration result, output image data suitable for each property of the printer engines. That is, the technique assumes merely a case where a printer, which is supposed to form the image, is specified.

Specifically, the respective properties of the image forming apparatuses vary according to each arrangement of the apparatuses and operating conditions thereof. However, when the output image data is transmitted to the common address of the image forming apparatuses, it is unknown which of the image forming apparatuses is supposed to carry out image forming of the output image data. This makes it impossible to carry out the image forming in accordance with each property of the image forming apparatuses.

### SUMMARY OF THE INVENTION

The present invention is made in view of the above problems. An object of the present invention is to provide an image forming system in which each of a plurality of image forming apparatuses is capable of carrying out image forming of output image data in accordance with each property of the image forming apparatuses.

To achieve the object, an image processing device, according to the present invention, for generating a plurality of output image data items for use in image forming carried out by at least one of a plurality of image forming apparatuses, the image processing device, comprising: (a) a storage section for storing gradation correction data items which are for use in generating, from image data, a plurality of output image data items subjected to gradation correction, respectively; (b) a set preparing section for (i) generating the output image data items by carrying out the gradation correction with respect to the image data in accordance with the gradation correction data items respectively, and (ii) preparing, in accordance with the gradation correction data items stored in the storage section, plural sets by rendering, to the output image data items, identification information for allowing the image forming apparatuses to identify the gradation correction data items used for the generation of the output image data items, respectively; and (c) a transmitting section for transmitting the plural sets to a common transmission destination of the image forming apparatuses.

The common transmission destination of the image forming apparatuses refers to, for example, an address which is common to the image forming apparatuses and which allows the image forming apparatuses to receive the same data from the image processing device. Therefore, the information transmission to the common transmission destination makes it possible for each of the image forming apparatuses to acquire the plural sets.

For example, see a case where each of the image forming apparatuses receives the output image data which is transmitted to the common transmission destination, and which is obtained by carrying out the gradation correction with respect to the image data. In this case, each of the image forming apparatuses can carry out the image forming of the output image data.

The identification information allows each of the image forming apparatuses to identify the gradation correction data. In other words, in reference to the identification information, each of the image forming apparatuses can acquire the condition of the gradation correction carried out with respect to the image data, i.e., details of the gradation correction data. Examples of the identification information include: (i) an ID for identifying the gradation correction data, (ii) intrinsic information (e.g. model number) for identifying the image forming section, and the like. See a case where the model number of the image forming section serves as the identification information. When there is gradation correction data suitable for a structure of each image forming section, the gradation correction data can be identified in accordance with the model number of the image forming section. Thus, the intrinsic information of the image forming section can be used as the identification information.

The output image data is data obtained by performing the gradation correction with respect to the image data. Therefore, the image forming in accordance with such output image data by the image forming apparatus allows output of a good image matching with the property of the image forming apparatus.

According to the above arrangement, the output image data is generated in accordance with each of the plural items of gradation correction data stored in the storage section. That is, plural patterns of the output image data are generated. Further, the plural sets are prepared by correlating the output image data with the identification information (e.g., gradation correction information concerning the gradation correction data) for identifying the gradation correction data used for the generation of the output image data. The plural sets thus prepared are transmitted to the destination common to the image forming apparatuses. With this, each of the image forming apparatuses can receive the plural sets via the common transmission destination. Each of the image forming apparatuses can select a suitable set from the plural sets in accordance with the identification information for identifying the gradation correction data contained in the plural sets. Specifically, the image forming apparatus can select the suitable one of the plural sets in accordance with the identification information for identifying the output image data subjected to the gradation correction data contained in each of the plural sets. This allows the image forming apparatus to carry out output of the output image data matching with the property of the image forming apparatus.

That is, the structure above makes it possible for the image processing device to prepare a set which allows each of the image forming apparatuses to carry out optimum output of the output image data and which is made up of the output image data and the identification information.

Thus, even in the case where it is unknown that which of the image forming apparatuses is supposed to carry out the image forming, the image is formed by an image forming apparatus having a property suitable for the image forming. A specific example of such a case is a case where an image forming instruction is sent to a plurality of image forming apparatuses each having the load distribution function.

In cases where the output image data is transmitted to an address of a printer group, the output image data is received by all the image forming apparatuses which belong to the printer group. In this case, the output image data received by the image forming apparatuses 1 are the same. So, determination of an image forming apparatus 1 which is supposed to carry out the image forming may be carried out by running a negotiation among the image forming apparatuses which received the output image data.

Further, it is preferable that the plural sets include sets suitable for the image forming apparatuses, respectively.

To achieve the object, an image forming apparatus according to the present invention includes: (a) an image forming section for carrying out image forming in accordance with output image data; (b) a receiving section for receiving plural sets, which are transmitted from an image processing device to a common transmission destination of image forming apparatuses, and each of which is made up of (i) the output image data subjected to gradation correction and (ii) identification information for identifying gradation correction data for use in generating the output image data; (c) a property acquiring section for acquiring a property of the image forming section; and (d) an output image data selecting section for selecting, from the plural sets, a set having output image data suitable for the image forming section.

Examples of the property of the image forming section include: (i) the current information indicative of the current state of the image forming section; and/or (ii) the ID (intrinsic information) for identifying the image forming section; and the like.

Further, the identification information is information for identifying the gradation correction data used for the generation of the output image data.

The plural sets, which are transmitted to the common transmission destination of the plural image forming apparatuses, can be received by the image forming apparatuses. Specifically, each of the image forming apparatuses receives the plural sets which are transmitted to the common transmission destination of the image forming apparatuses, i.e., transmitted to the image forming apparatuses, and which include (i) a set the most suitable for image forming carried out by an image forming section of an image forming apparatus; and (ii) respective sets the most suitable for image forming carried out by image forming sections of the other image forming apparatuses.

The arrangement above makes it possible that: a set suitable for the property of an image forming section is selected from the plural sets in accordance with the identification information contained in the set, and the image forming of the output image data contained in the set is carried out. In other words, the output image data selecting section selects, from the plural sets in accordance with the identification information, the set suitable for the image forming section so as to select the output image data which was subjected to the gradation correction corresponding to the property of the image forming section.

This makes it possible to carry out the image forming of the output image data subjected to the gradation correction corresponding to the property of the image forming apparatus.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram schematically illustrating respective structures of an image processing device and an image forming apparatus in an image forming system according to the present embodiment.

FIG. 2 is a block diagram schematically illustrating a structure of the image forming system of the present embodiment.

FIG. 3 is a flowchart illustrating a flow of information exchanged between the image forming apparatus and the image processing device.

FIG. 4 is a block diagram illustrating another example of a set preparing section of the image processing device.

FIG. 5 is a block diagram illustrating a major part of another example of the image processing device.

FIG. 6 is a block diagram schematically illustrating a structure of another example of the image forming system according to the present embodiment.

FIG. 7 is an explanatory diagram illustrating information exchanged between the image processing device and the image forming apparatus.

FIG. 8 is a diagram illustrating how to generate a set when image data is color data.

FIG. 9 is an explanatory block diagram fully illustrating a communication section, a printer engine, a status acquiring section, and a data storage section in the image forming apparatus.

FIG. 10 is a block diagram schematically illustrating a structure of an image forming system according to the present embodiment.

### DESCRIPTION OF THE EMBODIMENTS

### First Embodiment

The following describes one embodiment of the present invention. In an image forming system according to the present invention, an image processing device receives either (i) information indicative of each property of image forming means or (ii) gradation correction data, from the plurality of image forming apparatuses. Then, the image processing device generates output image data according to each property of the individual image forming apparatuses. Then, the image processing device transmits, to a common destination (common transmission destination) of the image forming apparatuses, plural sets each made up of (i) the output image data, and (ii) identification information allowing each of the image forming apparatuses to identify the gradation correction data. Then, each of the image forming apparatuses acquires a set that matches with the property of the image forming apparatus, and forms an image of the output image data.

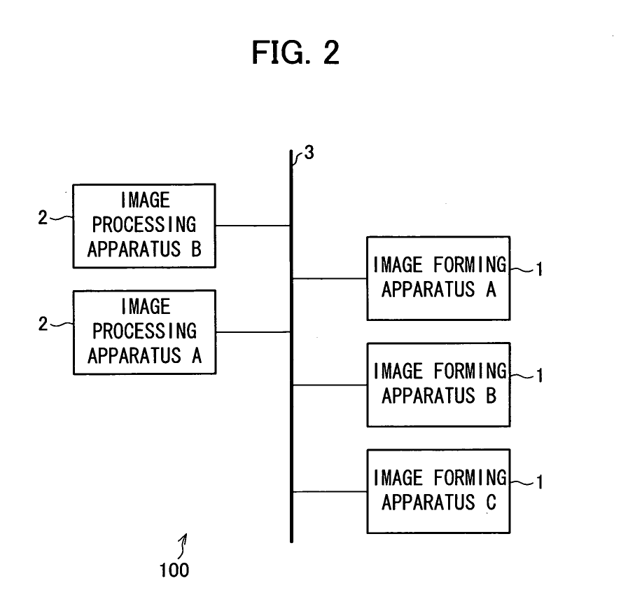

FIG. 2 is a block diagram schematically illustrating an image forming system 100 according to the present embodiment. As illustrated in FIG. 2, in the image forming system 100, a plurality of image processing devices 2 and a plurality of image forming apparatuses 1 are connected through a network 3. Note that, at least one of the image processing devices 2 may be provided.

Examples of each of the image forming apparatuses 1 are a printer, a facsimile, a digital multifunctional apparatus, and the like. The image forming apparatus 1 never carries out gradation correction with respect to the output image data transmitted from the image processing devices 2, but is capable of image forming of the output image data. Each of the image processing devices 2 generates the output image data by carrying out the gradation correction with respect to image data targeted for the image forming. Then, the image processing device 2 transmits the output image data to the image forming apparatus 1.

Each of the image forming apparatuses 1 can acquire the information transmitted to the common destination of the image forming apparatuses 1. Specifically, the image forming apparatuses 1 can acquire the same information transmitted to such a specific address. Note that, the image forming system 100 may be arranged such that not all the image forming apparatuses 1 but the specific plural number of the image forming apparatuses 1 receive the information transmitted to the common destination (address). In other words, the image forming system 100 may be arranged such that at least two of the image forming apparatuses 1 can receive the same information.

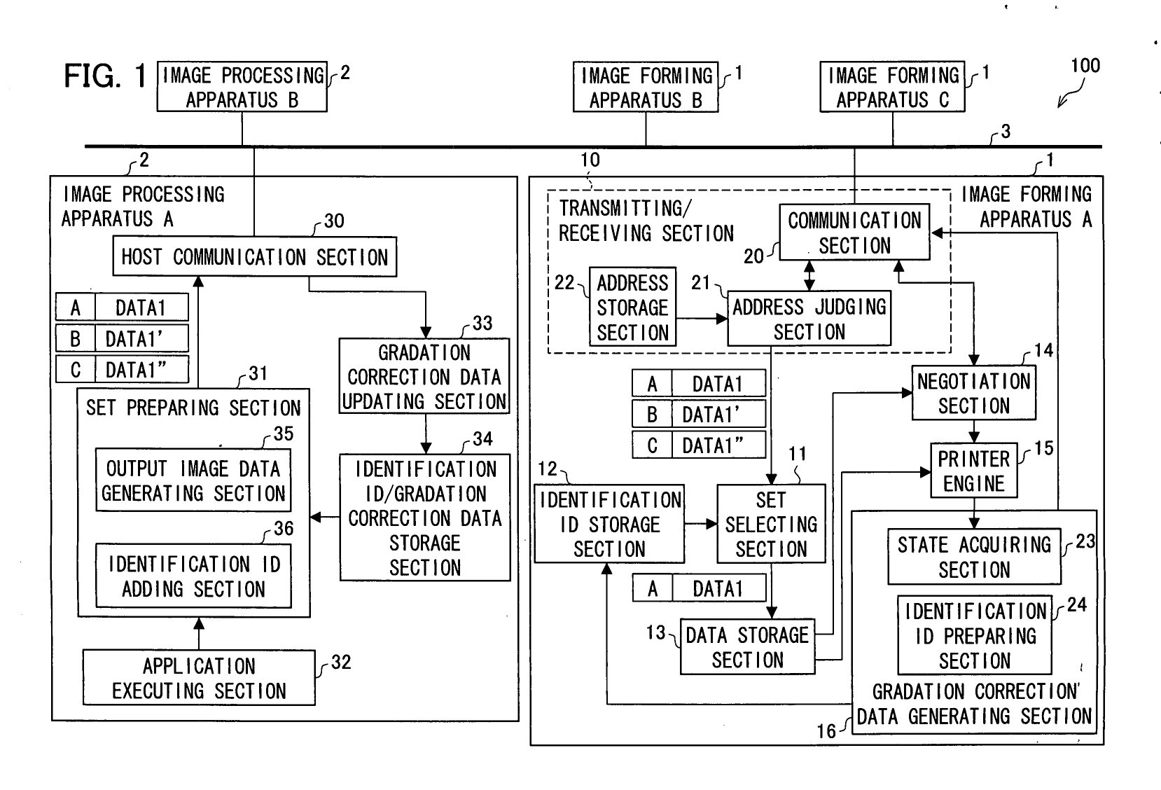

FIG. 1 is a block diagram schematically illustrating (i) an arrangement of each of the image processing devices 2 and (ii) an arrangement of each of the image forming apparatuses 1 in the image forming system 100 according to the present embodiment. The following describes the respective arrangements of the image processing device 2 and the image forming apparatus 1. Note that, the description below is made as to an arrangement in which the image processing device 2 prepares the plural sets with the use of respective specific IDs of the image forming apparatuses 1 as identification information. Although the following description deals with the arrangement of an image forming apparatus A1 illustrated in FIG. 2, image forming apparatuses B1 and C1 have the same arrangements as that of the image forming apparatus A1. Likewise, the arrangement of an image processing device A2 of the image processing devices 2 is described; however, an image processing device B2 has the same arrangement as that of the image processing device A2.

As illustrated in FIG. 1, the image forming apparatus 1 includes a transmitting/receiving section 10 (receiving means), a set selecting section 11 (output image data selecting means), an identification ID storage section 12, a data storage section 13, a printer engine 15 (image forming means), a gradation correction data generating section 16, and a negotiation section 14.

Here, when the image processing device 2 of the image forming system 100 according to the present embodiment makes an instruction for the image forming, the image data indicative of an image to be outputted is transmitted to the common address of the image forming apparatuses 1. For this reason, at the point of transmitting the image data, the image processing device 2 cannot specify an image forming apparatus 1 which is supposed to output the image.

Thus, as described later in detail, each of the image forming apparatuses 1 according to the present embodiment is so arranged as to transmit the output image data and identification information. The output image data is generated by performing the gradation correction with respect to the image data such that the image data is accommodated to the image forming apparatuses 1. The identification information specifies gradation correction data used for the generation of the output image data. In other words, the image forming apparatuses 1 respectively transmit sets each made up of (i) the output image data and (ii) the identification information for identifying the gradation correction data used for the generation of the output image data. Note that, the identification information makes it possible for each of the image processing devices 2 to identify the gradation correction data of the output image data contained in the identification information.

From the image processing device 2 described later, the transmitting/receiving section 10 receives the plural sets each made up of (i) the output image data obtained by carrying out the gradation correction with respect to the image data, and (ii) the identification information for identifying the gradation correction data used for the gradation correction carried out with respect to the image data. Specifically, the output image data of the plural sets are output image data items obtained by carrying out different types of the gradation correction with respect to one image data item, and the identification information of the plural sets identifies the gradation correction data items each used for such gradation correction. Therefore, the plural sets are made up of (i) the output image data items obtained by carrying out the different types of gradation correction with respect to one image, and (ii) the gradation correction data items used for the gradation correction. So, the plural sets are prepared in accordance with the image data generated by using an application or the like. Further, the transmitting/receiving section 10 transmits, to the image processing device 2, (i) current information indicative of a current state (present state) of the printer engine 15, and (ii) property information indicative of the gradation correction data and the property of the printer engine 15.

The transmitting/receiving section 10 includes a communication section 20, an address judging section 21, and an address storage section 22. The communication section 20 exchanges information with an external device such as the image processing device 2, the other image forming apparatuses 1, or the like.

The address storage section 22 stores an address intrinsic to the image forming apparatus 1, and the virtual address (common destination) common to the image forming apparatuses 1.

The address judging section 21 judges whether or not the information (the plural sets) is transmitted, via the communication section 20, to (i) the address intrinsic to each of the image forming apparatus 1 or (ii) the virtual address. Specifically, the address judging section 21 judges whether or not transmission destination information of the information transmitted via the communication section 20 matches the address stored in the address storage section 22. When the transmission destination information matches with the address, the address judging section 21 judges that the received information is destined for the address intrinsic to the apparatus, and transmits the information to the set selecting section 11 described later. On the other hand, when the address judging section 21 does not find the match, the address judging section 21 carries out an exceptional process.

From the plural sets transmitted via the transmitting/receiving section 10, the set selecting section 11 selects a set matching with the property of the printer engine 15 of the image forming apparatus 1. Specifically, the set selecting section 11 selects the set matching with the property of the printer engine 15, in accordance with (i) the identification information contained in each of the received sets, and (ii) an identification ID (apparatus ID, gradation ID) stored in the identification ID storage section 12 described later. The set selecting section 11 causes the data storage section 13 to store either the selected set or the output image data included in the selected set.

The identification ID storage section 12 stores the identification ID prepared by an identification ID preparing section 24 described later.

The data storage section 13 stores either the set selected by the set selecting section 11, or the output image data included in the set.

The printer engine 15 carries out image forming in accordance with the output image data stored in the data storage section 13.

The gradation correction data generating section 16 includes a state acquiring section 23 (property acquiring means) and the identification ID preparing section 24.

The state acquiring section 23 acquires the current property of the printer engine 15. Specifically, the state acquiring section 23 acquires the current information indicative of the current state of the printer engine 15. Examples of the current state of the printer engine 15 includes: temperature, humidity, image formation density, a frequency of the image formation, a time elapsed from the most recent image formation, and the like. The state acquiring section 23 includes a temperature sensor, a humidity sensor, a density sensor, a counter, a timer, and the like, which are not shown in figures. The temperature sensor and the humidity sensor measure temperature and humidity in the printer engine 15, respectively. The density sensor measures density of an image formed by the printer engine 15, the counter counts how many times the printer engine 15 carries out image forming, and the timer measures time elapsed from a predetermined point of time such as the activation of the printer engine 15 or the most recent image formation. The state acquiring section 23 acquires such various kinds of information, thereby acquiring the current information.

The identification ID preparing section 24 prepares the identification ID for identifying the current information acquired by the state acquiring section 23. It is more preferable that the identification ID have a portion indicating the current information.

The gradation correction data generating section 16 generates the gradation correction data in accordance with the current information acquired by the state acquiring section 23. Further, the gradation correction data generating section 16 transmits, to the image processing device 2, (i) the generated gradation correction data, and (ii) the identification ID prepared by the identification ID preparing section 24. Then, the gradation correction data generating section 16 causes the identification ID storage section 12 to store the identification ID.

The negotiation section 14 negotiates with the other image forming apparatuses 1 about the image forming of the output image data. In the present embodiment, the plural sets transmitted from the image processing device 2 to the virtual address can be received by any image forming apparatus 1 having the address storage section 22 storing the virtual address. That is, the plural sets are received by plural image forming apparatuses 1. In this case, when all the image forming apparatuses 1 carry out the image forming of the output image data, the same output image data will be outputted from the image forming apparatuses 1. Therefore, the negotiation section 14 negotiates with the other image forming apparatuses 1, and determines an image forming apparatus 1 which will carry out the image forming. Further, in cases where the output of the output image data is carried out by a different image forming apparatus 1, the negotiation section 14 deletes the output image data, which is stored in the data storage section 13 of the foregoing image forming apparatus 1 and which is the same with the output image data to be outputted by the different image forming apparatus 1.

Note that, the description above assumes an example in which the identification ID preparing section 24 prepares the identification ID used for identifying the current information acquired by the state acquiring section 23. However, the present invention is not limited to the above example. For example, the identification ID preparing section 24 may prepare an identification ID (apparatus ID) used for identifying the image forming apparatus 1. In this case, the same identification ID may be always prepared, or a different identification ID may be prepared according to each of the generated gradation correction data.

Next described is the arrangement of the image processing device 2.

As illustrated in FIG. 1, the image processing device 2 includes a host communication section 30, a set preparing section 31, an application executing section 32, a gradation correction data updating section 33, and a gradation ID/gradation correction data storage section 43.

The host communication section 30 transmits the plural sets at least to the virtual address, i.e., the common destination of the image forming apparatuses 1. Further, from the image forming apparatuses 1, the host communication section 30 receives various information such as the current information indicative of the current state of each of the image forming apparatuses 1, the gradation correction data, the identification ID, and the like.

The gradation correction data updating section 33 receives the gradation correction data and the identification ID, each of which is transmitted from the image forming apparatus 1 via the host communication section 30. Then, the gradation correction data updating section 33 causes the identification ID/gradation correction data storage section 34 to store the received identification ID and the gradation correction data. When the received identification ID matches with the identification ID stored in the identification ID/gradation correction data storage section 34, the gradation correction data updating section 33 updates the information stored in the identification ID/gradation correction data storage section 34. That is, when finding that the stored identification ID matches the received identification ID, the gradation correction data updating section 33 updates the identification ID stored in the identification ID/gradation correction data storage section 34.

The identification ID/gradation correction data storage section 34 stores a combination of the identification ID and the gradation correction data. Normally, the identification ID/gradation correction data storage section 34 stores plural combinations of the identification IDs and the gradation correction data, each of which is transmitted from the image forming apparatuses 1.

The application executing section 32 executes an application provided in the image processing device 2. Further, the application executing section 32 generates the image data targeted for the image forming.

The set preparing section 31 prepares plural combinations of (i) the output image data obtained by carrying out the gradation correction with respect to the image data, and (ii) the identification IDs for identifying gradation correction data used for generating the output image data. More specifically, in order to generate the output image data, the set preparing section 31 uses (i) the image data generated by the application executing section 32 and (ii) the identification ID and the gradation correction data each stored in the identification ID/gradation correction data storage section 34, and then the identification ID is rendered to the output image data thus generated, with the result that the set is prepared. Thereafter, the set preparing section 31 prepares the sets whose number corresponds to the number of the combinations of the identification IDs and the gradation correction data each stored in the identification ID/gradation correction data storage section 34. The set preparing section 31 handles these sets as the plural sets.

The set preparing section 31 includes an output image data generating section 35 and an identification ID adding section 36. The output image data generating section 35 performs the gradation correction with respect to the image data in accordance with the gradation correction data stored in the identification ID/gradation correction data storage section 34, with the result that the output image data is generated. Then, the identification ID adding section 36 adds, to the output image data, the identification ID which corresponds to the gradation correction data for use in generating the output image data.

In this way, the plural sets are prepared in the image processing device 2.

Note that, the above description explains the example in which the image processing device 2 includes the application executing section 32. However, the image processing device 2 may be arranged such that: e.g., the image data is transmitted from an outside to the image processing device 2, and the plural sets are prepared in the image processing device 2. That is, the image processing device 2 does not necessarily need to generate the image data, but prepares the plural sets.

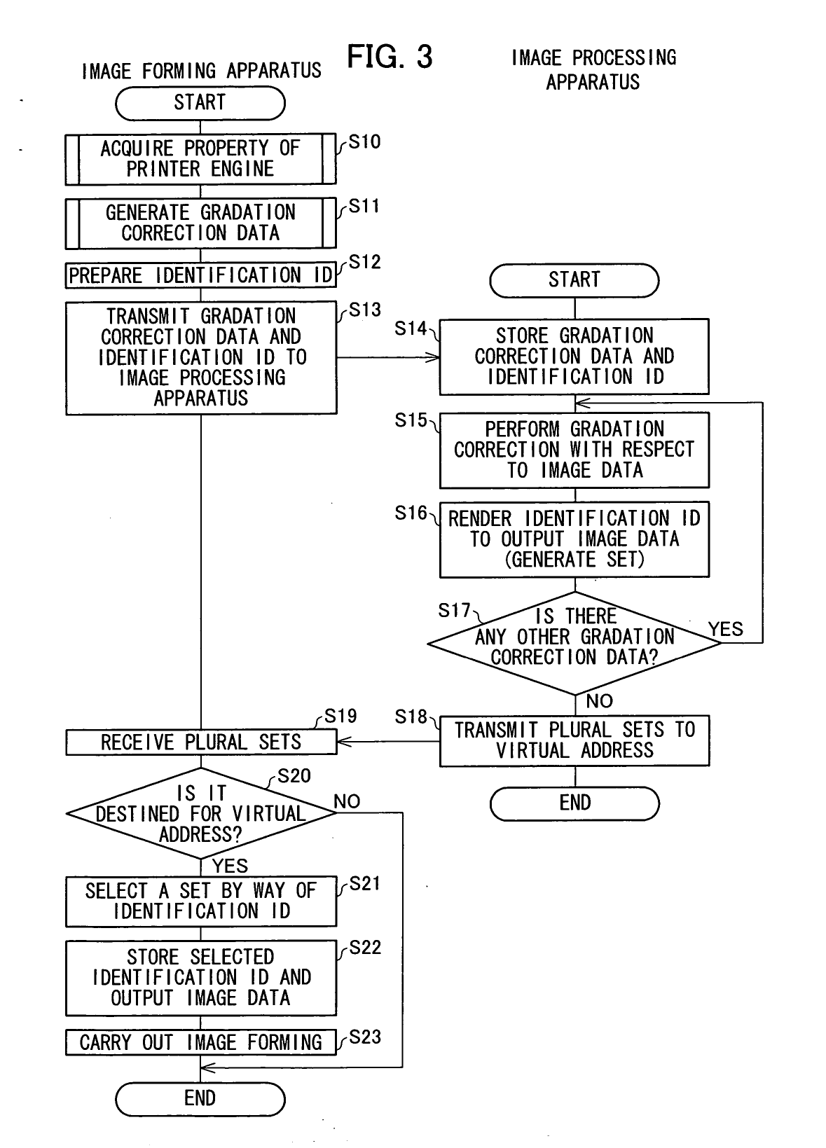

FIG. 3 is a flowchart illustrating a flow of exchanging information between the image forming apparatus 1 and the image processing device 2. Described here are processes of the image forming carried out as follows. That is, the image forming apparatus 1 transmits the gradation correction data and the identification ID to the image processing device 2. The image processing device 2 prepares the plural sets including the output image data obtained by carrying out the gradation correction, and transmits the plural sets to the image forming apparatus 1. From the plural sets, the image forming apparatus 1 selects a set matching with the property of the printer engine 15.

First, the state acquiring section 23 of the image forming apparatus 1 acquires the current information indicative of the current state of the printer engine 15 (S10).

Next, the gradation correction data generating section 16 generates the gradation correction data in accordance with the current information acquired by the state acquiring section 23 (S11).

Thereafter, the gradation correction data generating section 16 causes the identification ID preparing section 24 to operate for the preparation of the identification ID intrinsic to the current information (S12). Then, the gradation correction data generating section 16 transmits the combination of the generated gradation correction data and the identification ID to the image processing device 2 via the communication section 20 (S13). Further, the gradation correction data generating section 16 stores the identification ID in the identification ID storage section 12.

The image processing device 2 receives the gradation correction data and the identification ID, from the image forming apparatus 1 via the host communication section 30. Then, the image processing device 2 transmits the received combination of the gradation correction data and the identification ID to the gradation correction data updating section 33. The gradation correction data updating section 33 stores the received combination of the gradation correction data and identification ID into the identification ID/gradation correction data storage section 34 (S14).

Next, in accordance with the gradation correction data stored in the identification ID/gradation correction data storage section 34, the output image data generating section 35 in the set preparing section 31 performs the gradation correction with respect to the image data generated by the application executing section 32 (S15). Specifically, for the gradation correction of the image data, the set preparing section 31 acquires the combination of the identification ID and the gradation correction data, each of which is stored by the identification ID/the gradation correction data storage section 34. Then, the identification ID is temporarily stored in the identification ID adding section 36. In accordance with the gradation correction data thus acquired, the output image data generating section 35 of the set preparing section 31 carries out the gradation correction of the image data, with the result that the output image data is obtained.

Next, the identification ID adding section 36 in the set preparing section 31 renders the temporarily stored ID, to the output image data generated by the output image data generating section 35 (S16). This allows preparation of the set having the identification ID rendered to the output image data.

Next, the set preparing section 31 judges whether or not another combination of the gradation correction data and the identification ID is still stored in the identification ID/gradation correction data storage section 34 (S17). When the set preparing section 31 judges that the combination is still stored therein, the set preparing section 31 repeats the above processes of the steps S15 and S16 so as to prepare a set.

On the other hand, see a case where the set preparing section 31 judges that no combination is stored therein. That is, when the set preparing section 31 judges that the identification ID/gradation correction data storage section 34 stores no gradation correction data to be subjected to the gradation correction, the set preparing section 31 transmits the plural sets as a single file (data) to the common destination, i.e., the virtual address of the image forming apparatuses 1 (S18).

When the communication section 20 of the image forming apparatus 1 receives the plural sets transmitted to the virtual address (S19), the address judging section 21 judges whether or not the received plural sets are destined for the virtual address (S20). Specifically, the address judging section 21 judges whether or not the address information rendered to the plural sets matches the virtual address stored in the address storage section 22. When there is a match, it can be judged that the plural sets are destined for the virtual address.

When the address judging section 21 judges that the plural sets are destined for the virtual address, the plural sets are transmitted to the set selecting section 11. On the other hand, when the address judging section 21 judges that the plural sets are not destined for the virtual address, the exceptional process is carried out. The exceptional process refers to such a process that: e.g., various processes are carried out in accordance with a type of information when the address matches the address of the image forming apparatus, whereas the plural sets are deleted when the address corresponds to the address of a different image forming apparatus.

When receiving the plural sets, the set selecting section 11 selects, in accordance with the identification IDs respectively rendered to the sets, a set whose identification ID matches the identification ID stored in the ID storage section 12 (S21). Then, the set selecting section 11 stores the selected set in the data storage section 13 (S22).

Next, the printer engine 15 carries out the image forming of the output image data stored in the data storage section 13 (S23).

In this way, the image processing device 2 can prepare the output image data corresponding to the property of the printer engine 15 of each of the image forming apparatuses 1. On the other hand, the image forming apparatus 1 can carry out the image forming matching with the property of the printer engine 15 thereof.

As described above, an image processing device 2 according to the present embodiment includes: (1) an identification ID/gradation correction data storage section (storage means) 34 for storing gradation correction data items which are for use in generating, from image data, the output image data items subjected to gradation correction, respectively; (2) a set preparing section (set preparing means) 31 for (i) generating the output image data items by carrying out the gradation correction with respect to the image data in accordance with the gradation correction data items respectively, and (ii) preparing, in accordance with the gradation correction data items stored in the identification ID/gradation correction data storage section 34, plural sets by rendering, to the output image data items, identification information for identifying the gradation correction data items used for the generation of the output image data items, respectively; and (3) a set preparing section (transmitting means) 31 for transmitting the plural sets to a common transmission destination of the image forming apparatuses 1 via the host communication section 30.

The common transmission destination of the image forming apparatuses 1 refers to, for example, an address, which is common to the image forming apparatuses 1 and which allows the image forming apparatuses 1 to receive the same data from the image processing device 2. Therefore, the information transmission to the common transmission destination makes it possible for each of the image forming apparatuses 1 to acquire the plural sets.

For example, see a case where each of the image forming apparatuses 1 receives the output image data which is transmitted to the common transmission destination, and which is obtained by carrying out the gradation correction with respect to the image data. In this case, each of the image forming apparatuses 1 can carry out the image forming of the output image data.

The identification information allows each of the image forming apparatuses to identify the gradation correction data. In other words, in reference to the identification information, each of the image forming apparatuses can acquire the condition of the gradation correction carried out with respect to the image data, i.e., details of the gradation correction data.

Examples of the identification information include: (i) an ID for identifying the gradation correction data, (ii) intrinsic information (e.g. model number) for identifying the printer engine 15, and the like. See a case where the model number of the printer engine 15 serves as the identification information. When there is gradation correction data suitable for each structure of the printer engines 15, the gradation correction data can be identified in accordance with the model number of the printer engine 15. Thus, the intrinsic information of the printer engine 15 can be used as the identification information.

The output image data is data obtained by performing the gradation correction with respect to the image data. Therefore, the image forming in accordance with such output image data by the image forming apparatus 1 allows output of a good image matching with the property of the image forming apparatus 1.

According to the above arrangement, the output image data is generated in accordance with each of the plural items of gradation correction data stored in the identification ID/gradation correction data storage section 34. That is, plural patterns of the output image data are generated. Further, the plural sets are prepared by correlating the output image data with the identification information (e.g., gradation correction information concerning the gradation correction data) for identifying the gradation correction data used for the generation of the output image data. The plural sets thus prepared are transmitted to the destination common to the image forming apparatuses 1. With this, each of the image forming apparatuses 1 can receive the plural sets via the common transmission destination. Each of the image forming apparatuses 1 can select a suitable set from the plural sets. Specifically, the image forming apparatus 1 can select the suitable one of the plural sets in accordance with the identification information for identifying the gradation correction data contained in each of the plural sets. This allows the image forming apparatus 1 to carry out output of the output image data matching with the property of the image forming apparatus 1.

That is, the structure above makes it possible for the image processing device 2 to prepare a set which allows each of the image forming apparatuses 1 to carry out optimum output of the output image data and which is made up of the output image data and the identification information.

Thus, even in the case where it is unknown that which of the image forming apparatuses 1 is supposed to carry out the image forming, the image is formed by an image forming apparatus 1 having a property suitable for the image forming. A specific example of such a case is a case where an image forming instruction is sent to a plurality of image forming apparatuses 1 each having the load distribution function.

In cases where the output image data is transmitted to an address of a printer group, the output image data is received by all the image forming apparatuses 1 which belong to the printer group. In this case, the output image data received by the image forming apparatuses 1 are the same. So, determination of an image forming apparatus 1 which is supposed to carry out the image forming may be carried out by running a negotiation among the image forming apparatuses 1 which received the output image data.

Further, it is preferable that the plural sets include sets suitable for the image forming apparatuses 1, respectively.

It is more preferable that the image processing device 2 according to the present embodiment further includes a gradation correction data updating section (acquiring means) 33 for acquiring, from the image forming apparatuses 1, the gradation correction data items corresponding to properties of the printer engines 15 of the image forming apparatuses 1, respectively, wherein: the set preparing section (set preparing means) 31 prepares the plural sets in accordance with the image data and the gradation correction data items acquired by the gradation correction data updating section 33.

According to the above arrangement, the plural sets are prepared in accordance with the gradation correction data transmitted from the image forming apparatus 1. This makes it possible that the image processing device 2 prepares the sets in accordance with the received gradation correction data. Therefore, the sets to be transmitted to the common transmission destination of the image forming apparatuses 1 are such sets that contain the output image data gradation-corrected suitably for the image forming apparatuses 1, respectively.

Note that, the gradation correction data updating section 33 may acquire not only the gradation correction data, but also the identification information for identifying the gradation correction data. In this case, the set preparing section 31 may prepare the sets with the use of the identification information thus acquired.

It is more preferable that the image processing device 2 according to the present embodiment further include: a host gradation data generating section 42 for (i) acquiring, from each of the image forming apparatuses 1, current information indicative of each of current states of the printer engines 15 of the image forming apparatuses 1, and (ii) generating each of the gradation correction data items in accordance with the current information, wherein: the set preparing section 31 prepares the plural sets in accordance with the image data and the gradation correction data items generated by the host gradation data generating section 42.

The above arrangement makes it possible for the image processing device 2 to generate the gradation correction data in accordance with the current information, which is transmitted from each of the image forming apparatuses 1 and is indicative of the current state of the printer engine 15 thereof.

It is more preferable to arrange the image processing device 2 according to the present embodiment such that: the set preparing section 31 includes a region dividing section (region dividing means) 70 for dividing the image data into (i) a correction region to be subjected to the gradation correction, and (ii) a non-correction region that is not to be subjected to the gradation correction; the set preparing section 31 prepares plural sets by carrying out the gradation correction with respect to the correction region of the image data; and the set preparing section 31 renders the non-correction region to the plural sets thus prepared.

The correction region to be subjected to the gradation correction, and the non-correction region to be subjected to no gradation correction are suitably determined according to a type of image data. Specifically, for example, see a case where the image data includes a letter region and a picture region. For the attainment of a good output image, the picture region needs to be subjected to the gradation correction, but the letter region possibly does not need to be subjected to the gradation correction. As such, some image data has (i) the region to be subjected to the gradation correction, and (ii) the region not to be subjected to the gradation correction.

According to the above arrangement, only when the gradation correction is required, the gradation correction is performed for the preparation of the plural sets. Then, the non-correction region not to be subjected to the gradation correction is added to the plural sets. With this, only one non-correction region is added to the plural sets. This allows reduction of a data amount of the data to be transmitted to the common transmission destination of the image forming apparatuses 1.

An image forming apparatus 1 according to the present embodiment includes: (a) a printer engine (image forming means) 15 for carrying out image forming in accordance with output image data; (b) a transmitting/receiving section (receiving means) 10 for receiving plural sets, which are transmitted from an image processing device 2 to a common transmission destination of image forming apparatuses 1, and each of which is made up of (i) the output image data subjected to gradation correction and (ii) identification information for identifying gradation correction data for use in generating the output image data; (c) a state acquiring section (property acquiring means) 23 for acquiring a property of the printer engine 15; and (d) a set selecting section (output image data selecting means) 11 for selecting, from the plural sets, a set having output image data suitable for the printer engine 15.

Examples of the property of the printer engine 15 include: (i) the current information indicative of the current state of the printer engine 15; and/or (ii) the ID (intrinsic information) for identifying the printer engine 15; and the like.

Further, the identification information is information for identifying the gradation correction data used for the generation of the output image data.

The plural sets, which are transmitted to the common transmission destination of the plural image forming apparatuses 1, can be received by the image forming apparatuses 1. Specifically, each of the image forming apparatuses 1 receives the plural sets which are transmitted to the common transmission destination of the image forming apparatuses 1, i.e., transmitted to the image forming apparatuses 1, and which include (i) a set the most suitable for image forming carried out by a printer engine 15 of an image forming apparatus 1; and (ii) respective sets the most suitable for image forming carried out by printer engines 15 of the other image forming apparatuses 1.

The arrangement above makes it possible that: a set suitable for the property of a printer engine 15 is selected from the plural sets in accordance with the identification information contained in the set, and the image forming of the output image data contained in the set is carried out. In other words, the set selecting section 11 selects, from the plural sets in accordance with the identification information contained in each of the plural sets, the set suitable for the printer engine 15 so as to select the output image data which was subjected to the gradation correction corresponding to the property of the printer engine 15.

This makes it possible to carry out the image forming of the output image data subjected to the gradation correction corresponding to the property of the image forming apparatus 1.

It is preferable that the image forming apparatus 1 according to the present embodiment further include: (a) a gradation correction data generating section (gradation correction data generating means) 16 for generating the gradation correction data in accordance with the property of the printer engine 15, which property is acquired by the state acquiring section 23; and (b) a transmitting/receiving section 10 for transmitting, to the image processing device 2, the gradation correction data and the identification information for identifying the gradation correction data.

According to the above arrangement, the image processing device 2 receives (i) the gradation correction data generated in accordance with the property of the printer engine 15 of the image forming apparatus 1, and (ii) the identification information for identifying the gradation correction data. This allows the image processing device 2 to prepare the set in accordance with the gradation correction data and the identification information.

Accordingly, the image forming apparatus 1 can receive the set containing the output image data generated by the image processing device 2, with the result that good image forming can be carried out in accordance with the gradation correction data obtained in accordance with the property of the printer engine 15 of the image forming apparatus 1.

It is more preferable to arrange the image forming apparatus 1 according to the present embodiment such that: the property of the printer engine 15 corresponds to current information indicative of a current state of the printer engine 15; and upon the image forming, the set selecting section 11 compares (i) the current information acquired by the state acquiring section 23 with (ii) the identification information contained in each of the plural sets, so as to select, from the plural sets, a set having output image data to be subjected to the image forming.

The state of the printer engine 15 varies according to, e.g., passage of time and/or an environmental change. Such passage of time and/or environment change causes a change in quality of an image outputted by the printer engine 15. In order to accommodate the change caused by the passage of time and/or the environmental change, the gradation correction is performed with respect to the image data to be subjected to the image forming. This allows reduction of an influence from these changes. Examples of factors having the influence over the condition of the printer engine 15 are temperature, humidity, density of a formed image, a frequency of the image formation, time elapsed from the most recent image formation, and the like.

According to the above arrangement, the image forming apparatus 1 can select the most suitable set from the plural sets in accordance with the current state of the printer engine 15. That is, the above arrangement makes it possible that the image forming can be carried out according to the current state of the printer engine 15.

It is preferable that the image forming apparatus 1 according to the present embodiment include a negotiation section 14 for negotiating with other image forming apparatuses 1 over the output image data to be subjected to the image forming.

The plural sets transmitted to the common transmission destination are to be received by each of the image forming apparatuses 1. In this case, it is necessary to determine an image forming apparatus 1 which is supposed to carry out the image forming.

The above arrangement makes it possible that: for the determination of the image forming apparatus 1 which is supposed to carry out the image forming, the negotiation section 14 of each of the image forming apparatuses 1 runs negotiation with the other image forming apparatuses 1.

The image forming system 100 according to the present embodiment includes the image processing device 2 and the image forming apparatuses 1.

According to the above arrangement, the output image data to be subjected to the image forming is transmitted to the common transmission destination of the image forming apparatuses 1. This allows each of the image forming apparatuses 1 to select suitable output image data. Accordingly, even when the image forming apparatus 1 which is supposed to carry out the image forming is not known, good image forming can be carried out.

Further, it is preferable that the image forming system 100 according to the present embodiment further include: a data transferring device 4 for determining, from the image forming apparatuses 1, an image forming apparatus that is supposed to carry out image forming of the output image data.

The image processing device 2 according to the present embodiment may be arranged such that: the image data is divided into (i) the correction region to be subjected to the gradation correction and (ii) the non-correction region not to be subjected to the gradation correction, and only the correction region to be subjected to the gradation correction is subjected to the gradation correction process such that the output image data is generated, and the non-correction region is rendered to the plural sets each made up of the output image data and the identification information, and the plural sets are transmitted to the virtual address. In this case, each of the image forming apparatuses 1 may separate the plural sets from the non-correction region, and stores, into the data storage section 13, a combination of (i) the output image data contained in a set selected by the set selecting section 11 and (ii) the non-correction region. The following description provides details on this.

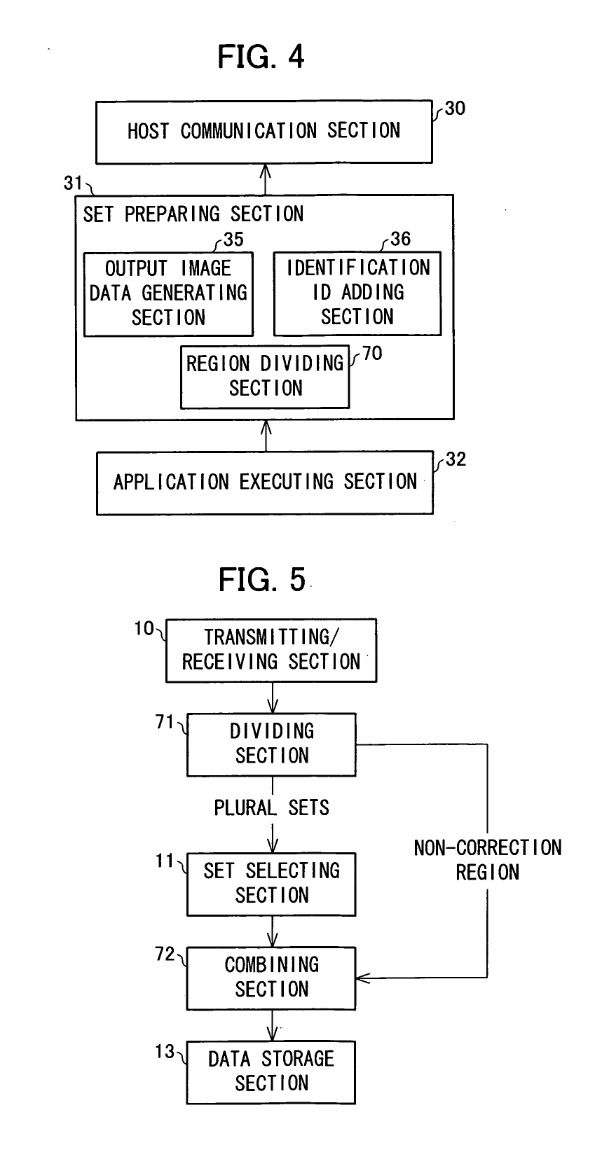

FIG. 4 is a block diagram illustrating another example of the set preparing section 31 of the image processing device 2. As illustrated in FIG. 4, the set preparing section 31 may include the region dividing section 70 (region dividing means).

The region dividing section 70 divides the image data, which is generated by the application executing section 32, into (i) the correction region to be subjected to the gradation correction and (ii) the non-correction region not to be subjected to the gradation correction. Specifically, for example, see a case where the image data includes a letter region and a picture region. For the attainment of a good output image, the picture region needs to be subjected to the gradation correction, but the letter region possibly does not need to be subjected to the gradation correction. In such a case, the picture region corresponds to the correction region, and the letter region corresponds to the non-correction region.

Firstly for the preparation of the set, the region dividing section 70 carries out region dividing of the image data generated by the application executing section 32. Then, the output image data generating section 35 carries out the gradation correction with respect to only the correction region of the divided image data so as to generate the output image data. Thereafter, the set preparing section 31 prepares the plural sets by rendering the identification IDs to the generated output image data, respectively. Then, the non-correction region is rendered to the plural sets, and is transmitted to outside, i.e., the virtual address.

On the other hand, in the case where the image processing device 2 includes the region dividing section 70, the image forming apparatus 1 includes a dividing section 71 and a combining section 72 as illustrated in FIG. 5.

The dividing section 71 divides, into the plural sets and the non-correction region, the data which is transmitted via the transmitting/receiving section 10 and which includes the plural sets to which the non-correction region is rendered. Then, the dividing section 71 transmits the plural sets to the set selecting section 11, while transmitting the non-correction region to the combining section 72. Further, the set selecting section 11 selects a specific set from the plural sets, and transmits the selected set to the combining section 72.

The combining section 72 combines (i) the output image data obtained by carrying out the gradation correction with respect to the correction region of the image data contained in the selected set, with (ii) the non-correction region. In this way, the data to be subjected to the image forming is generated, and is stored in the memory section.

As such, the above arrangement allows reduction of an amount of information of the plural sets, thereby reducing an amount of the information transmitted from the image processing device 2 to each of the image forming apparatuses 1.

Incidentally, in the above description, the identification ID is prepared by the identification ID preparing section 24 in accordance with the current information. However, the method for preparing the identification ID is not limited to this. For example, the apparatus ID specific to each of the apparatuses may be used as the identification ID. In this case, no identification ID preparing means may be provided. The following describes how this case is different from the above description.

First, the apparatus ID specific to each of the image forming apparatuses 1 is stored in advance in the identification ID storage section 12 of the image forming apparatuses 1.

When the state acquiring section 23 of the image forming apparatus 1 acquires the current information indicative of the current property of the printer engine 15 of the image forming apparatus 1, the gradation correction data generating section 16 generates the gradation correction data in accordance with the current information. Then, the gradation correction data generating section 16 transmits, to the image processing device 2, a combination of (i) the gradation correction data and (ii) the apparatus ID stored in the identification ID storage section 12.

The gradation correction data updating section 33 of the image processing device 2 judges whether or not the received ID matches information stored in the identification ID/gradation correction data storage section 34. When it is judged that the received ID does not match the information, the gradation correction data updating section 33 stores the received gradation correction data and the apparatus ID into the identification ID/gradation correction data storage section 34. On the other hand, when it is judged that the received ID matches the information, the gradation correction data updating section 33 updates, in accordance with the received gradation correction data, the gradation correction data which is correlated with an apparatus ID identical to the received apparatus ID, and which is stored in the identification ID/gradation correction data storage section 34. In other words, when the apparatus ID identical to the received apparatus ID exists in the identification ID/gradation correction data storage section 34, the gradation correction data updating section 33 updates the gradation correction data stored in the identification ID/gradation correction data storage section 34. The processes coming after this are as described above.

As such, when the apparatus ID specific to each of the image forming apparatuses 1 is used as the identification ID, the identification ID does not need to be rendered to each gradation correction data.

Further, the above description assumes that: upon the image forming, the negotiation section 14 sends the image forming instruction to the printer engine 15. The following description provides details on this.

Each image forming apparatus 1 whose address storage section 22 stores the virtual address receives the plural sets transmitted to the virtual address, so that the image forming apparatus 1 can carry out the image forming in accordance with the output image data matching the property of the printer engine 15 thereof. However, in this case, the image forming will be carried out by each of the image forming apparatuses 1 in accordance with the same image data. For this reason, in the present embodiment, the negotiation section 14 is provided in the image forming apparatus 1 so as to determine an image forming apparatus 1 which will carry out the image forming.

Specifically, the negotiation section 14 performs negotiation so as to determine an image forming apparatus 1 which will carries out the output of the set stored in the data storage section 13. This allows determination of the image forming apparatus 1 which will carry out the output of the output image data.

Incidentally, the above example explains the case where each of the image forming apparatuses 1 receive the plural sets transmitted from the image processing device 2 to the virtual address. In other words, the above example explains the arrangement in which the plural image forming apparatuses 1 receive the same information. However, the image forming apparatuses 1 may not need to receive the same information in cases where, e.g., the data transferring device 4 having the load distribution function allocates, to their destinations, the plural sets to be transmitted. A specific example of the data transferring device 4 is a server. The following description provides details on this.

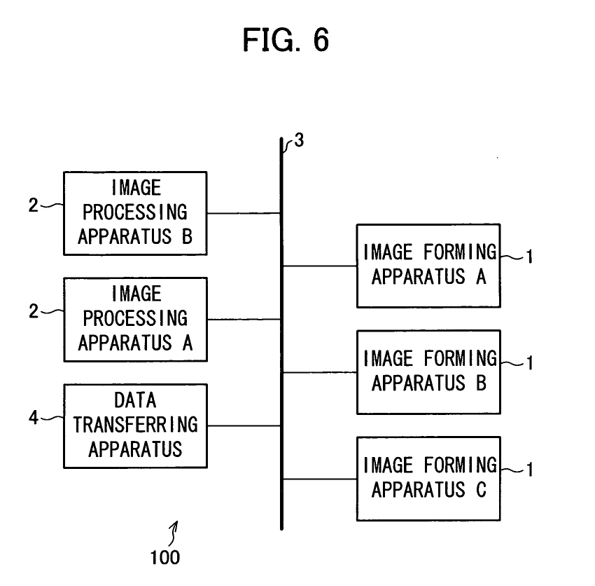

FIG. 6 is a block diagram schematically illustrating a structure of another example of the image forming system 100 according to the present embodiment.

As illustrated in FIG. 6, the image forming system 100 includes the image processing devices 2, printers (image forming apparatuses 1), and the data transferring device 4, each of which is connected to one another via the network 3. In the example, the virtual address corresponds to the address of the data transferring device 4. In this case, the image processing device 2 prepares and transmits the plural sets to the data transferring device 4 by way of the virtual address, i.e., the address of the data transferring device 4.

The data transferring device 4 first determines a printer to which the received plural sets are transmitted. Then, the data transferring device 4 transmits the plural sets to the printer thus determined. The arrangement allows determination of the printer which is supposed to receive the plural sets, so that the negotiation sections 14 may not need to be provided in each of the printers. As such, in cases where the data transferring device 4 is provided in the image forming system 100 of the present embodiment, the negotiation section 14 does not need to be provided in each of the printers.

Further, the image forming apparatus 1 of the present embodiment is not limited to a single independent apparatus, and may be constituted by a plurality of apparatuses. Specifically, in the above example, the image forming apparatus 1 of the present embodiment is constituted by the data transferring device 4 and the printer.

The above description explains the case where the information transmitted from the image forming apparatus 1 to the image processing device 2 includes (i) the identification ID (the apparatus ID and the gradation ID) and (ii) the gradation correction data or the current information, and where the above identification information is identical to the identification ID contained in each of the plural sets transmitted from the image processing device 2 to the image forming apparatus 1. However, the identification ID transmitted from the image forming apparatus 1 to the image processing device 2 may be different from the identification ID transmitted from the image processing device 2 to the image forming apparatus 1. The following description provides details on this.

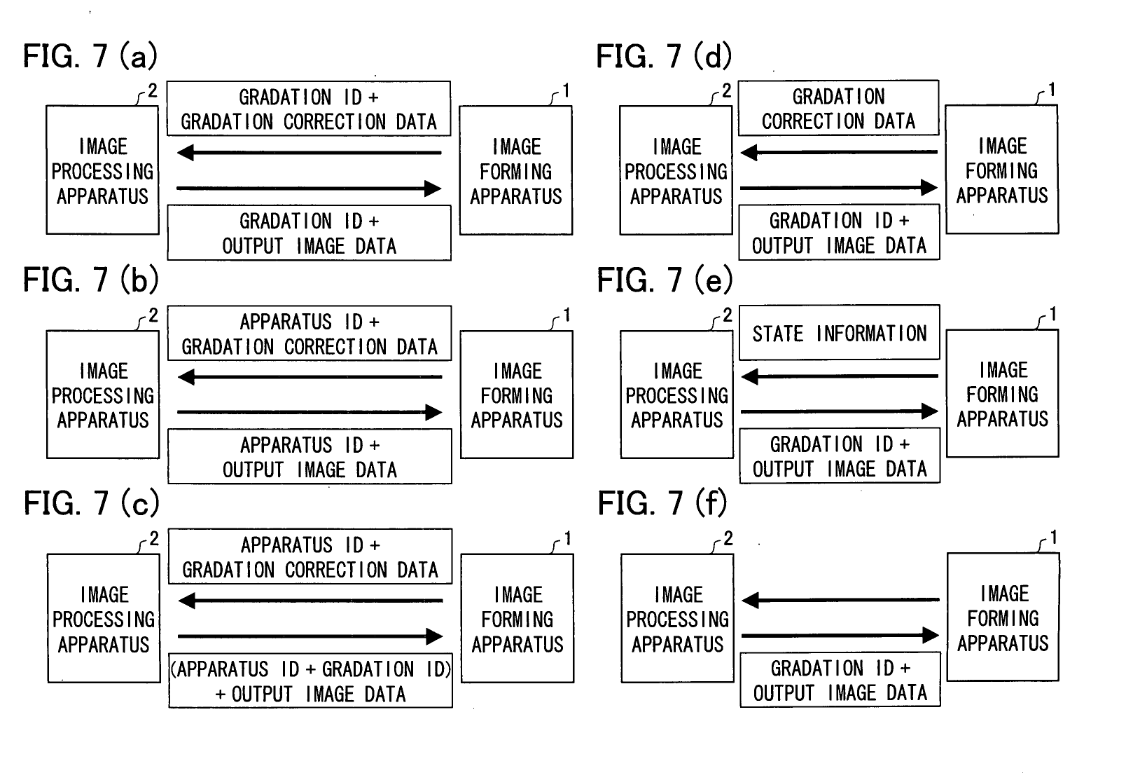

FIG. 7 is a diagram illustrating information exchange between the image processing device 2 and the image forming apparatus 1.

The above description corresponds to FIG. 7(a) and FIG. 7(b). Specifically, each of FIG. 7(a) and FIG. 7(b) illustrates that: the image forming apparatus 1 transmits, to the image processing device 2, the gradation correction table and the identification data (apparatus ID or gradation ID); whereas the image processing device 2 transmits, to the image forming apparatus 1, the set made up of (i) the identification data identical to the above identification data and (ii) the output image data.

However, the present invention is not limited to this. The receipt and transmission of the identification ID may be carried out, e.g., as follows. See FIG. 7(c). The image forming apparatus 1 transmits, to the image processing device 2, the gradation correction data and the apparatus ID; whereas the image processing device 2 transmits, to the image forming apparatus 1, an identification ID obtained by combining (i) the apparatus ID and (ii) the gradation ID for identifying the gradation correction data used for the generation of the output image data.

An alternative example is illustrated in FIG. 7(d). That is, the image forming apparatus 1 transmits only the gradation correction data to the image processing device 2; whereas the image processing device 2 transmits, to the image forming apparatus 1, (i) the output image data and (ii) the gradation ID for identifying the gradation data used for the generation of the output image data. In this case, the image processing device 2 analyzes the gradation correction data so as to prepare the gradation ID. Further, in this case, the gradation ID is prepared by the image processing device 2 in accordance with the method by which the identification ID preparing section 24 of the image forming apparatus 1 prepares the identification ID.

See an alternative example shown in FIG. 7(e). In cases where the gradation correction data is generated by the image processing device 2, the image forming apparatus 1 may transmit only the current information to the image processing device 2, whereas the image processing device 2 may transmit, to the image forming apparatus 1, (i) the output image data and (ii) the gradation ID for identifying the gradation correction data used for the generation of the output image data. This will be explained in another embodiment.

See a further alternative example shown in FIG. 7(f). The image processing device 2 generates a large amount of the gradation correction data according to variations of the current information, and generates the output image data in accordance with the gradation correction data thus generated. Then, the image processing device 2 transmits, to the image forming apparatus 1, the output image data and the gradation ID for identifying the gradation correction data.

Further, when the image forming apparatus 1 receives, from the image processing device 2, the plural sets each made up of (i) the gradation ID containing the current information and (ii) the output image data, the set selecting section 11 may temporarily store the plural sets. When the image forming apparatus 1 actually carries out the image forming, the set selecting section 11 may select, from the plural sets thus temporarily stored, a set suitable for the current state of the printer engine 15. Specifically, upon the image forming, the state acquiring section 23 acquires the current information, and the identification ID preparing section 24 prepares the identification ID in accordance with the current information thus acquired, and the identification ID thus prepared is stored in the identification ID storage section 12. Then, in accordance with the identification ID, the set selecting section 11 select a set from the temporarily stored plural sets in accordance with the identification ID. This makes it possible to select a set that is the most suitable at the moment of actually operating the printer engine 15. Accordingly, the optimum image forming can be always carried out even in cases where, e.g., the moment of receiving the image data (set) does not coincide with the moment of actually carrying out the image forming. A specific example of such a case is the hold printing or the like.

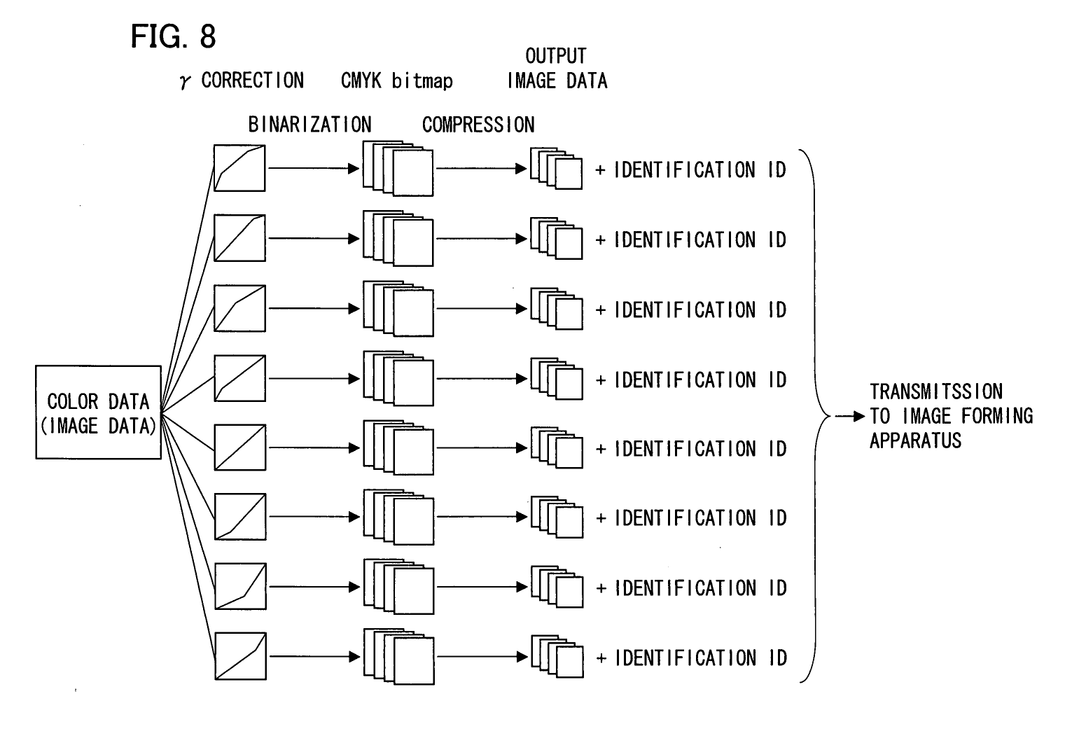

FIG. 8 is a diagram illustrating a method for preparing each of the sets in cases where the image data is color data. Explained here is how the sets are prepared by the set preparing means of the image processing device 2 when the image data is the color data.

As illustrated in FIG. 8, the set is prepared with the use of the color data as follows. That is, the γ correction is carried out with respect to the color data. Thereafter, the color data thus γ-corrected is binarized, and is subjected to the CMYK bit map process. Then, a compressing process is carried out with respect to the color data, with the result that the output image data is generated. Then, the identification ID (gradation ID) is rendered to the output image data thus obtained. The identification ID identifies the gradation correction data used for the generation of the output image data. In this way, the set is prepared. Carried out thereafter is preparation of the plural sets each made up of the output image data and the identification ID. The preparation is carried out in a manner similar to the manner described above. Then, the plural sets thus prepared are transmitted to the image forming apparatus 1.

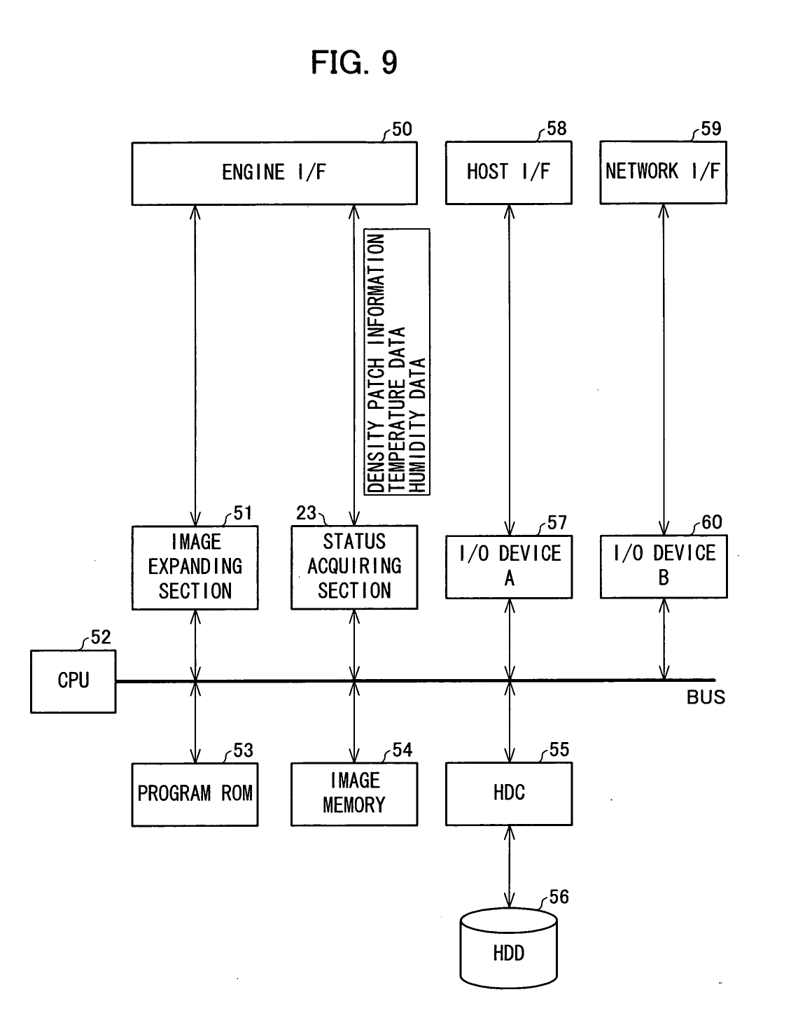

FIG. 9 is a block diagram fully illustrating the communication section 20, the printer engine 15, the state acquiring section 23, and the data storage section 13 in the image forming apparatus 1. These are explained below.

As illustrated in FIG. 9, the communication section 20 of the image forming apparatus 1 includes a host I/F 58, an I/O device A57, a network I/F 59, and an I/O device B60. A specific example of the host I/F 58 is the USB or the like. Further, a specific example of the network I/F 59 is a wireless LAN or the like. The I/O device A57 exchanges information between the inside of the image forming apparatus 1 and the host I/F 58. Meanwhile, the I/O device B60 exchanges information between the inside of the image forming apparatus 1 and the network I/F 59.

Via the host I/F 58 and/or network I/F 59, the image forming apparatus 1 exchanges various kinds of information with outside such as the image processing device 2.

The data storage section 13 includes an HDC 55, an HDD 56, and an image memory. The HDD 56 is a hard disk (large capacity storage apparatus), and the HDC 55 is a hard disk controller. Further, the image memory serves as a buffer for temporarily storing the output image data when the printer engine 15 is used to carry out the image forming of the output image data stored in the HDD 56. Further, the output image data is stored in the data storage section 13.

The printer engine 15 includes an engine I/F 50, an image expanding section 51, and a program ROM 53. The output image data is expanded by the image expanding section 51, and the output image data thus expanded is transmitted to the engine I/F 50. Then, the engine I/F 50 carries out the image forming of the output image data. The program ROM 53 stores various kinds of programs for use in the image forming.

The state acquiring section 23 acquires the current information via the engine I/F 50. Examples of the current information are density patch information, temperature data, humidity data, and the like.

Further, the image processing device 2 according to the present embodiment may include (a) the identification ID/gradation correction data storage section 34 for storing (i) the gradation correction data used for the gradation correction carried out with respect to the image data, and (ii) the identification information for identifying the gradation correction data, such that the gradation correction data and the identification information are correlated with each other; (b) the output image data generating section 35 for generating the output image data by carrying out the gradation correction with respect to the image data in accordance with the gradation correction data stored in the identification I/D gradation correction data storage section 34, (c) the set preparing section 31 for preparing each of the sets by correlating (i) the output image data with (ii) the gradation correction information concerning the gradation correction data used for the generation of the output image data, and (d) the transmitting/receiving section 10 for transmitting the plural sets thus prepared, to the address of the printer group made up of the image forming apparatuses 1.

Further, the image processing device 2 according to the present embodiment may include: (a) the gradation correction data updating section 33 for acquiring, from the image forming apparatuses 1 belonging to the printer group, the current information indicating the current state of each of the printer engines 15 of the image forming apparatuses 1; and (b) the host gradation data generating section 42 for generating the gradation correction data in accordance with the current information, wherein: the identification ID/gradation correction data storage section 34 stores the gradation correction data generated by the gradation correction data generating means.

Further, the image processing device 2 according to the present embodiment may include: (a) the identification ID/gradation correction data storage section 34 for storing the gradation correction data such that the gradation correction data is correlated with the printer and the printer group of the printers; (b) the output image data generating section 35 for generating the print data in accordance the original image data with the use of the gradation correction data of each of the printers belonging to the printer group designated for the print output by the user; (c) the identification ID adding section 36 for rendering, to the print data, the identification information (ID) of the gradation correction data corresponding to the generated print data; and (d) the set preparing section 31 for transmitting, to the address of the printer group, the print data correlated with the identification information. This makes it possible to provide the host apparatus (information processing apparatus) and each of the printers (image forming apparatuses 1), whereby the printing can be carried out according to the property of the printer engine 15 even when a printer which will carry out the printing is not specified as is the case with the virtual printer and when the host apparatus generates the print data. Further, even in cases where the printer which will carry out the printing is not determined, the printing of the print data will be able to be carried out by a suitable printer.

The image processing device 2 according to the present embodiment may further include the gradation correction data updating section 33 for updating the contents in the identification ID/gradation correction data storage section 34 in response to the reception of the gradation correction data which contains the identification information (ID) and which is transmitted from each of the printers. This allows generation of the print data with the use of the newest gradation correction data.

The image forming apparatus 1 according to the present embodiment may include: (i) the printer engine 15; (ii) the identification ID/gradation correction data storage section 34 for storing the print data; (iii) the transmitting/receiving section 10 for receiving one or more items of the print data which is generated from the original image data and which has the identification information (ID) of the gradation correction data; and (iv) the print data selecting means for selecting and storing, in the identification ID/gradation correction data storage section 34, the print data corresponding to the identification information of the gradation correction data, which identification information matches with the identification information (ID) of the image forming apparatus 1. With this, only required print data is accumulated, with the result that the identification ID/gradation correction data storage section 34 can be used effectively.

### Second Embodiment

The following describes another embodiment of the present invention. For ease of explanation, materials having the equivalent functions as those shown in the drawings pertaining to the foregoing First Embodiment will be given the same reference symbols, and explanation thereof will be omitted here.

In the image forming system 100 according to the present embodiment, the image processing device 2 generates the gradation correction data. Specifically, the image processing device 2 receives, from each of the image forming apparatuses 1, the current information of the printer engine 15, and generates the gradation correction data in accordance with the current information thus received. Thereafter, the image processing device 2 transmits, to the virtual address, the plural sets each made up of the output image data and the identification information for identifying the gradation correction data used for the generation of the output image data. When each of the image forming apparatuses 1 receives the plural sets transmitted from the image processing device 2 to the virtual address, the image forming apparatus 1 selects an output image to be subjected to the image forming. The selecting is carried out in accordance with the identification information. The following explains this.

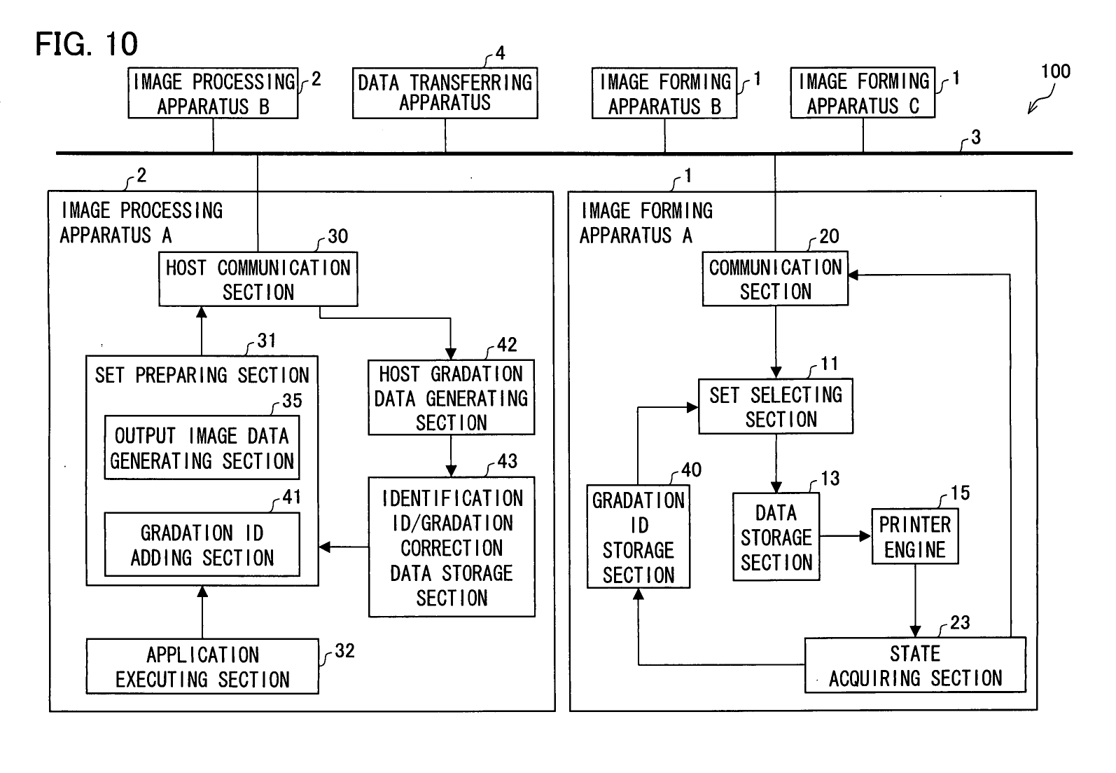

FIG. 10 is a block diagram schematically illustrating the structure of the image forming system 100 according to the present embodiment. The image forming system 100 includes the data transferring device 4. When the data transferring device 4 receives the plural sets from the image processing device 2, the transferring apparatus 4 allocates, to the image forming apparatuses 1 of the image forming system 100, the plural sets to be transmitted. Specifically, the data transferring device 4 judges the load to be imposed on each of the image forming apparatuses 1, in order to determine a transmission destination of the plural sets. With this, the image forming can be carried out optimally in the system.

Further, the image processing device 2 according to the present embodiment includes the host communication section 30, the host gradation data generating section 42, the gradation ID/gradation correction data storage section 43, the set preparing section 31, and the application executing section 32.

The host gradation data generating section 42 generates the gradation correction data in accordance with the current information transmitted from the image forming apparatus 1, and prepares the gradation ID for identifying the gradation correction data.

Further, the gradation ID/gradation correction data storage section 43 stores the combination of the (i) gradation correction data generated by the host gradation data generating section 42, and (ii) the gradation ID.

The set preparing section 31 includes the gradation ID adding section 41 and the output image data generating section 35. The gradation ID adding section 41 renders the gradation ID to the output image data generated by the output image data generating section 35.

On the other hand, each of the image forming apparatuses 1 includes the communication section 20, the set selecting section 11, the gradation ID preparing section 40, the data storage section 13, the state acquiring section 23, and the printer engine 15.

The gradation ID preparing section 40 prepares the gradation ID in accordance with the current information, acquired by the state acquiring section 23, of the printer engine 15. Note that, when the current information is unchanged, the gradation ID prepared by the gradation ID preparing section 40 coincides with the gradation ID for identifying the gradation correction data generated by the host gradation data generating section 42 of the image processing device 2. In other words, as long as the current information is unchanged, the gradation ID prepared by the gradation ID preparing section 40 coincides with the gradation ID prepared by the host gradation data preparing section 42.

Further, the state acquiring section 23 acquires the current information of the printer engine 15, and transmits the current information to the image processing device 2 via the communication section 20.

Explained here is a flow of the information in the image forming system 100 according to the present embodiment.

Firstly, the state acquiring section 23 of the image forming apparatus 1 acquires the current information of the printer engine 15, and transmits the current information to the image processing device 2. On this occasion, the gradation ID preparing section 40 acquires the current information from the state acquiring section 23 so as to prepare the gradation ID.

The host gradation data generating section 42 of the image processing device 2 acquires the current information from the image forming apparatus 1, and then generates the gradation correction data and prepares the gradation ID in accordance with the current information thus acquired. The combination of the gradation correction data and the gradation ID is stored in the gradation ID/gradation correction data storage section 43.

Further, in accordance with the image data, the gradation correction data, and the gradation ID, the set preparing section 31 prepares the plural sets each made up of the output image data and the gradation ID. Thereafter, the image processing device 2 transmits the plural sets to the address (virtual address) of the data transferring device 4.

When the data transferring device 4 receives the plural sets, and the data transferring device 4 determines an image forming apparatus 1 to which the plural sets are transmitted. Then, the plural sets are transmitted to the image forming apparatus 1 thus determined.

When the image forming apparatus 1 receives the plural sets, the image forming apparatus 1 selects, from the plural sets, a set having the gradation ID coinciding with the gradation ID prepared by the gradation ID preparing section 40. Thereafter, the set is stored in the data storage section 13, and then the image forming is carried out. In this way, the image forming of the output image data generated by the image processing device 2 is carried out.

Finally, each block of the image forming apparatus 1 and the image processing device 2 may be constituted by a hardware logic, or may be realized by a software with the use of a CPU as follows.

That is, each of the image forming apparatus 1 and the image processing device 2 includes: (i) the CPU 52 (central processing unit) for executing an instruction of a control program realizing the function; (ii) a ROM (read only memory) for storing the program; (iii) a RAM (random access memory) for expanding the program; (iv) a memory apparatus (recording medium) such as a memory for storing the program and various types of data; and the like. Therefore, the object of the present invention is achieved by: (i) providing, in each of the image forming apparatus 1 and the image processing device 2, a storage medium in which a computer-readable program code (executable program, intermediate code program, a source program) of the program for controlling the image forming apparatus 1 and the image processing device 2. The control program is software for realizing the function is stored, and (ii) causing a computer (or CPU 52, MPU (micro processing unit)) to read out and execute the program code stored in the storage medium.

Examples of the storage medium are: tapes such as a magnetic tape and a cassette tape; magnetic disks such as a floppy® disk and a hard disk; optical disks such as a CD-ROM (compact disk read only memory), a magnetic optical disk (MO), a mini disk (MD), a digital video disk (DVD), and a CD-R (CD-Rewritable); and the like. Further, the storage medium may be: a card such as an IC card (including a memory card) and an optical card; or a semiconductor memory such as a mask ROM, an EPROM (electrically programmable read only memory), an EEPROM (electrically erasable programmable read only memory), or a flash ROM.

Further, the program code may be supplied to each of the image forming apparatus 1 and the image processing device 2 via the communication network 3 to which each of the image forming apparatus 1 and the image processing device 2 is connectable. The communication network 3 is not particularly limited. Specific examples thereof are: the Internet, intranet, extranet, LAN (local area network), ISDN (integrated services digital network), VAN (value added network), CATV (cable TV) communication network, virtual private network, telephone network, mobile communication network, satellite communication network, and the like. Further, the transmission medium constituting the communication network is not particularly limited. Specific examples thereof are: (i) a wired line using an IEEE1394, a USB (universal serial bus), a power-line communication, a cable TV line, a telephone line, a ADSL line, or the like; or (ii) a wireless line using IrDA, infrared rays used for a remote controller, Bluetooth®, IEEE802.11, HDR (High Data Rate), a mobile phone network, a satellite connection, a terrestrial digital network, or the like. Note that the present invention can be realized by a computer data signal which represents the aforesaid program code, and which is electrically transmitted, and which is embedded in a carrier wave.

As such, the wording “means” in the specification encompasses not only physical means but also the case where the function of each means is realized by the software. Further, the function of one means may be realized by two or more physical means. Likewise, the functions of two or more means may be realized by one physical means.

Further, the image forming system is suitably applicable in cases where a plurality of image processing device and a plurality of image forming apparatus are connected one another via a network.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An image processing device for generating a plurality of output image data items for use in image forming carried out by at least one of a plurality of image forming apparatuses,
said image processing device, comprising:
a storage section for storing gradation correction data items which are for use in generating, from image data, the output image data items subjected to gradation correction, respectively;
a set preparing section for (i) generating the output image data items by carrying out the gradation correction with respect to the image data in accordance with the gradation correction data items respectively, and (ii) preparing, in accordance with the gradation correction data items stored in the storage section, plural sets by rendering, to the output image data items, identification information for allowing the image forming apparatuses to identify the gradation correction data items used for the generation of the output image data items, respectively; and
a transmitting section for transmitting the plural sets to a common transmission destination of the image forming apparatuses.

2. The image processing device as set forth in claim 1, further comprising:
an acquiring section for acquiring, from the image forming apparatuses, the gradation correction data items corresponding to properties of image forming sections of the image forming apparatuses, respectively,
wherein:
the set preparing section prepares the plural sets in accordance with the image data and the gradation correction data items acquired by the acquiring section.

3. The image processing device as set forth in claim 1, further comprising:
a gradation correction data generating section for (i) acquiring current information indicative of each of current states of image forming sections of the image forming apparatuses, and (ii) generating each of the gradation correction data items in accordance with the current information,
wherein:
the set preparing section prepares the plural sets in accordance with the image data and the gradation correction data items generated by the gradation correction data generating section.

4. The image processing device as set forth in claim 1, wherein:
the set preparing section includes a region dividing section for dividing the image data into (i) a correction region to be subjected to the gradation correction, and (ii) a non-correction region that is not to be subjected to the gradation correction;
the set preparing section prepares plural sets by carrying out the gradation correction with respect to the correction region of the image data; and
the set preparing section renders the non-correction region to the plural sets thus prepared.

5. An image processing device for generating output image data for use in image forming carried out by at least one of a plurality of image forming apparatuses,
said image processing device, comprising:
a storage section for storing a plurality of gradation correction data items, each of which is obtained by carrying out gradation correction with respect to image data, and each of which is used for generation of the output image data;
a set preparing section for (i) generating the output image data in accordance with each of the gradation correction data items, and (ii) preparing, in accordance with the gradation correction data items stored in the storage section, plural sets each made up of (a) the output image data and (b) the identification information for identifying the gradation correction data items used for the generation of the output image data, respectively; and
a transmitting section for transmitting the plural sets to a common transmission destination of the image forming apparatuses.

6. An image forming apparatus, comprising:
an image forming section for carrying out image forming in accordance with output image data;
a receiving section for receiving plural sets, which are transmitted from an image processing device to a common transmission destination of image forming apparatuses, and each of which is made up of (i) the output image data subjected to gradation correction and (ii) identification information for identifying gradation correction data for use in generating the output image data;
a property acquiring section for acquiring a property of the image forming section; and
an output image data selecting section for selecting, from the plural sets in accordance with the identification information and the property of the image forming section, a set having output image data suitable for the image forming section.

7. The image forming apparatus as set forth in claim 6, further comprising:
a gradation correction data generating section for generating the gradation correction data in accordance with the property of the image forming section, which property is acquired by the property acquiring section; and
a transmitting section for transmitting, to the image processing device, the gradation correction data and the identification information for identifying the gradation correction data.

8. The image forming apparatus as set forth in claim 6, wherein:
the property of the image forming section corresponds to current information indicative of a current state of the image forming section; and
upon the image forming of the output image data, the output image data selecting section compares (i) the current information acquired by the property acquiring section with (ii) the identification information contained in each of the plural sets, so as to select, from the plural sets, a set having output image data to be subjected to the image forming.

9. The image forming apparatus as set forth in claim 6, further comprising:
a negotiation section for negotiating with other image forming apparatuses so as to determine an image forming apparatus which is supposed to carry out outputting of the output image data.

10. An image forming system, comprising:
an image processing device for generating a plurality of output image data items for use in image forming carried out by at least one of a plurality of image forming apparatuses, said image processing device including (a) a storage section for storing gradation correction data items which are for use in generating, from image data, the output image data items subjected to gradation correction, respectively; (b) a set preparing section for (i) generating the output image data items by carrying out the gradation correction with respect to the image data in accordance with the gradation correction data items respectively, and (ii) preparing, in accordance with the gradation correction data items stored in the storage section, plural sets by rendering, to the output image data items, identification information for allowing the image forming apparatuses to identify the gradation correction data items used for the generation of the output image data items, respectively; and (c) a transmitting section for transmitting the plural sets to a common transmission destination of the image forming apparatuses, and
each of the image forming apparatuses including: (a) an image forming section for carrying out the image forming in accordance with each of the output image data items; (b) a receiving section for receiving the plural sets, which are transmitted from the image processing device to the common transmission destination of the image forming apparatuses, and each of which is made up of (i) the output image data item subjected to gradation correction and (ii) the identification information for identifying the gradation correction data items for use in generating the output image data items; (c) a property acquiring section for acquiring a property of the image forming section; and (d) an output image data selecting section for selecting, from the plural sets in accordance with the identification information and the property of the image forming section, a set having an output image data item suitable for the image forming section.

11. The image forming system as set forth in claim 10, further comprising:
a data transferring device for determining, from the image forming apparatuses, an image forming apparatus that is supposed to carry out image forming of the output image data.

12. An image processing program functioning as the sections of the image processing device as set forth in claim 1.

13. A computer-readable recording medium for storing the image processing program as set forth in claim 12.

14. An image forming program functioning as the sections of the image forming apparatus as set forth in claim 6.

15. A computer-readable recording medium for storing the image forming program as set forth in claim 14.
